(19) United States
(12) Patent Application Publication
(10) Pub. No.: US 2025/0335768 A1
(43) Pub. Date: Oct. 30, 2025

(54) EXPANDED NEURAL NETWORK TRAINING LAYERS FOR CONVOLUTION

(71) Applicant: Intel Corporation, Santa Clara, CA (US)

(72) Inventors: Anbang Yao, Beijing (CN); Chao Li, Beijing (CN); Xiaolong Liu, Beijing (CN); Wenjian Shao, Shanghai (CN); Feng Chen, Morgan Hill, CA (US)

(73) Assignee: Intel Corporation, Santa Clara, CA (US)

(21) Appl. No.: 18/855,584

(22) PCT Filed: May 16, 2022
(86) PCT No.: PCT/CN2022/093146

§ 371 Date: Oct. 9, 2024

(51) Int. Cl. G06N 3/082; G06N 3/0464

(52) U.S. Cl. CPC G06N 3/082; G06N 3/0464

(57) ABSTRACT

A computer model is trained with an architecture including additional training layers relative to the inference architecture. The architecture of a computer model to be used in inference includes a convolutional layer with a number of K×K convolutional filters. For training, the convolutional filters are expanded to a plurality of training layers including a layer with 1×1 and K×K filters. The expanded layers may include additional layers than the number of expanded filters in the layer of the inference model. The 1×1 expanded layer in training may learn weights for combining the K×K expanded layers, providing a weighted combination of the K×K filters for the respective channel of the layer of the inference layer.

### CROSS REFERENCE TO PRIOR APPLICATION

This application is a national stage application under 35 U.S.C. § 371 of International Application No. PCT/CN2022/093146, filed May 16, 2022, entitled “EXPANDED NEURAL NETWORK TRAINING LAYERS FOR CONVOLUTION,” which is incorporated herein by reference in its entirety.

### TECHNICAL FIELD

This disclosure relates generally to computer modeling and more particularly to training neural network models having convolutional filters.

### BACKGROUND

Convolutional Neural Networks (CNNs) have become the predominant learning models to handle a variety of Artificial Intelligence (AI) applications such as image classification, face recognition, scene understanding and Go games. Current technical trends show increasingly complex CNN architectures of increasing depth and complexity. While state-of-the-art CNN architectures may include various techniques for improving model training and accuracy, often such models become increasingly complex and come at the cost of increasing the cost of executing the model when used to inference (e.g., to apply the trained model to an input to generate an output). As such, many techniques that improve CNN performance also increase runtime inference cost and may thus be less attractive when inference is performed on lower-performance processors or when the increased computational load of the improvement requires tradeoffs with other processes competing for processing capacity. Techniques that improve model performance without increasing cost at inference may thus provide substantial benefit.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is an example flow for training parameters of a model architecture using expanded training layers, according to one embodiment.

FIG. 2 shows another example of expanded training layers, according to one embodiment.

FIG. 3 shows an example training model architecture for a convolutional layer, according to one embodiment.

FIG. 4 shows example computer model inference and computer model training.

FIG. 5 illustrates an example neural network architecture.

FIG. 6 is a block diagram of an example computing device that may include one or more components used for training, analyzing, or implementing a computer model in accordance with any of the embodiments disclosed herein.

### DETAILED DESCRIPTION

### Overview

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

This disclosure provides an approach for training convolutional layers with significantly better model accuracy while adding no additional computational cost to the inference (i.e., keeping the same typology of a target model at inference). An inference model architecture may be a convolutional layer of a number of K×K convolutional filters (also termed convolutional kernels) that result in a number of output channels in the layer's output data. K may be any suitable value such as 3, 5, 7, etc. The inference model architecture is expanded to a training model architecture and the convolutional layer (or at least some convolutional filters) are replaced with expanded training layers. The expanded training layers includes a layer of K×K filters and a layer of 1×1 filters. The number K×K filters in the expanded training layer may exceed the number of convolutional filters in the convolutional layer for the inference model architecture. The number of 1×1 filters in the 1×1 layer may match the number of convolutional filters in the training layer, such that the output of the 1×1 filters is a number of channels matching the number of output channels. The K×K layer may be considered to learn a number of different convolutional filters, which may exceed the number of convolutional filters of the inference model, while the 1×1 layer may be considered to learn a weighted combination of the resulting data from the expanded K×K layer. To apply learned values to the inference model architecture, values of the expanded training layers are “absorbed” such that the parameters from the expanded training layer are combined to mathematically-equivalent values as K×K filters for the trained inference model to be used for inference. Stated another way, due to the structure of the expanded layers, the parameters for a particular output channel in the trained convolutional layer may be determined directly from the trained parameters of the expanded training layers without expected loss of mathematical accuracy.

Given a CNN architecture built with regular convolutions or its variants, this approach thus transforms the regular convolutional kernel at any convolutional layer into two (or more) sequential convolutional layers of K×K convolutional kernels and a 1×1 convolutional kernel during the training, while transforming them back into one single convolutional layer with the regular K×K convolutional kernel, enjoying improved final model performance while also retaining the same inference cost. This approach is also compatible with many other model training approaches.

As such, this “absorbable” convolution is a drop-in design to improve training of convolutional filters of a neural network. It can be readily used to train these models with better model accuracy while adding no additional computational cost to inference (i.e., keeping the same typology of a target CNN model at inference).

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

In the following detailed description, reference is made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. The meaning of “a,” “an,” and “the” include plural references. The meaning of “in” includes “in” and “on.”

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. The accompanying drawings are not necessarily drawn to scale. The terms “substantially,” “close,” “approximately,” “near,” and “about,” generally refer to being within +/−20% of a target value. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

### Expanded Convolution in Training Layers

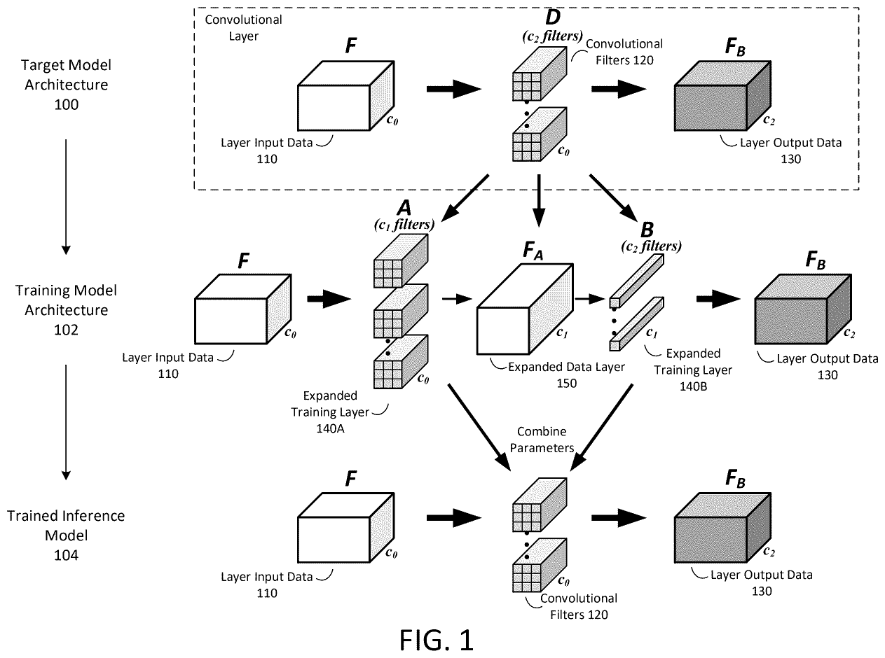

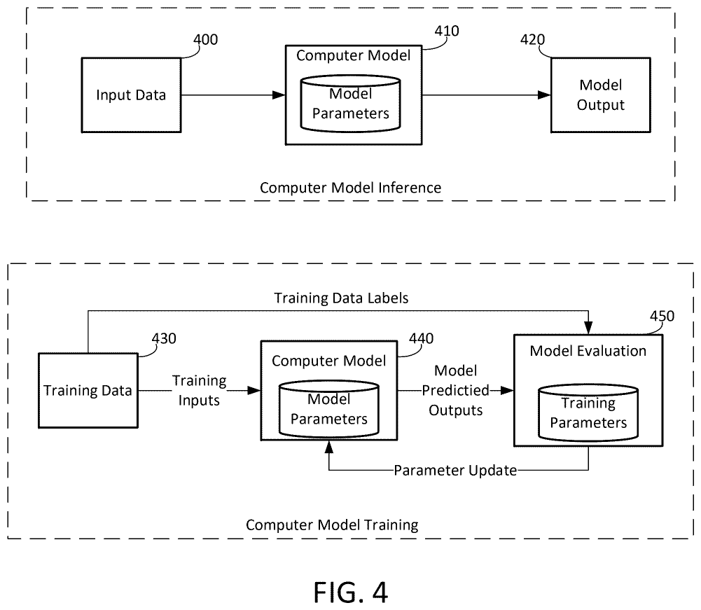

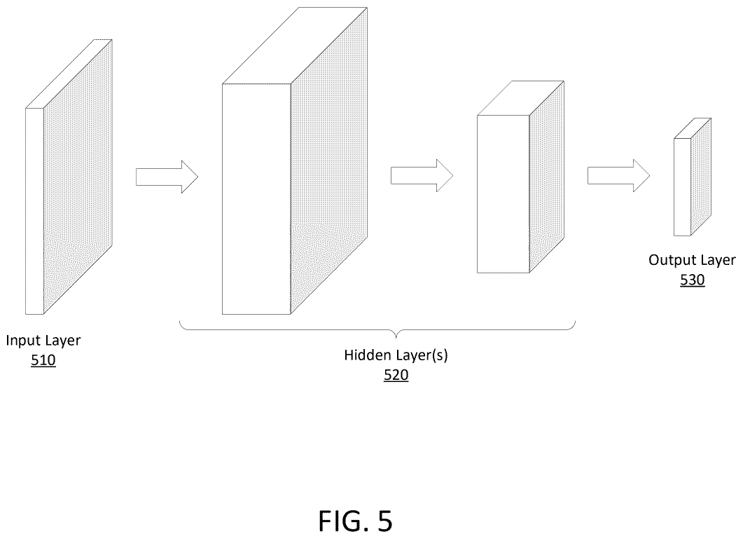

FIG. 1 is an example flow for training parameters of a model architecture using expanded training layers, according to one embodiment. A target model architecture 100 includes a convolutional layer that includes convolutional filters 120 that process layer input data 110 to layer output data 130. The target model architecture 100 is the model architecture to be used in deployment of the model when the model applies learned parameters to input data to generate an output. As discussed below with respect to FIGS. 4-5, computer models typically include parameters that are used to process inputs to predict outputs. Such computer models may be iteratively trained to learn particular parameters, including weights, for predicting various outputs based on input data. As discussed further in FIG. 5, individual layers in a neural network may receive input activations and process the input activations to generate output activations for the respective layer. Computer models that may be trained using the disclosed approaches may include the types discussed below, including various types of neural networks including at least one convolutional layer.

The layer input data 110 represents the data input to the model, which may be activations from a prior layer (e.g., outputs of the prior layer). Likewise, the layer output data 130 represents the output of the convolutional filters 120 applied to the layer input data 110 and is the output of the layer for the next step in the target model architecture 100. The layer input data 110 is referred to as a matrix F with a height and weight H×W, along with a depth that that represents a number of channels of the layer input data 110. The number of channels in the layer input data 110 is designated c₀. The layer input data 110 applied to each of the convolutional filters 120 generates respective channels for the received input. The convolutional filters 120 may be applied to different portions of the input to generate different corresponding outputs that together form the output of the layer output data 130, designated here as matrix F_{B}.

The number of convolutional filters 120 is denoted c₂ and thus generates a corresponding number of channels c₂ of the layer output data 130. The convolutional layers also have a size indicating the size of the inputs processed by each filter. In the example of FIG. 1, the convolutional filters 120 have a size of 3×3, indicating it receives the channels for a 3×3 region of the layer input data 110. The size of the filter may represent the portion of the height and width of the matrix received by the convolutional filter. As such, a filter having a size 3×3 may receive and process a 3×3×c₀ portion of inputs from the layer input data 110. As the layer input data 110 has a number of channels c₀, the convolutional filters 120 also may have parameters to be learned for each of the channels c₀ across the input size. The size for the convolutional filters 120 may be 3×3, 5×5, 7×7, and so forth, representing different sizes of the layer input data 110 to be processed by a given convolutional layer as the layer is applied to portions of the layer input data 110. The size is typically square and may be represented generally as K×K, such that the number of convolutional filters (c₂) each processes the K×K×c₀ matrix with the respective parameters of the filter. The convolutional filters 120 in the convolutional layer of the target model architecture 100 may also be referred to as D. As such, the layer output data 130 may be defined as the layer input data 110 with convolutions according to the convolutional filters: F_{B}=F*D, where * denotes a convolutional operation. For one channel of the output, the channel may be given by:

$${F}_{B : , : , 1} = {\sum }_{l = 1}^{{c}_{0}} {D}_{: , : , l}^{1} * {F}_{: , : , l} \qquad Equation 1$$

As shown in Equation 1, each output channel is the sum of each element in the convolutional filter multiplied by the corresponding elements of the layer input data.

In various embodiments, rather than directly training the parameters of the target model architecture 100, the convolutional filters 120 of the convolutional layer are expanded into two or more expanded training layers 140 in a training model architecture 102. After training the parameters of the training model architecture 102, the parameters for the convolutional layer are determined by combining the parameters of the expanded training layers 140. As such, the training model architecture 102 provides additional layers relative to the target model architecture and after training the parameters of the expanded training layers 140 are “absorbed” to determine the parameters for the trained inference model 104. As discussed below, the combined parameters of the trained inference model 104 are equivalent to the expanded training layers 140. This permits the training model architecture 102 to use the additional expanded training layers 140 (and the additional parameters) to provide additional “space” that may enable the training model architecture 102 to learn the training objective more accurately, while still being effectively combined for the convolutional filters 120 without expected mathematical loss.

As shown in FIG. 1, the convolutional layer D is replaced in the training model architecture 102 with expanded training layers 140A and 140B, including filters having a size of 3×3 (e.g., K×K) and 1×1, respectively. The expanded training layer 140B may have the same number of filters as the convolutional filters 120 (i.e., c₂) such that the output of the expanded training layer 140B is the same layer output data 130 having channels c₂. The expanded training layer 140B may thus be considered an output expanded layer such that its output is to be the learned output of the convolutional layer in the inference network. The input to the expanded training layer 140B is an expanded data layer 150 that is generated as the output of the expanded training layer 140A. That is, the expanded training layer 140A receives the layer input data 110, generates channels for the expanded data layer 150, which the expanded training layer 140B processes to generate the layer output data 130. The expanded data layer 150 is thus an intermediate data layer that represents channels of the output from the expanded training layer 140B. As shown in FIG. 1, the number of filters c₁ of the expanded training layer 140B yields the expanded data layer 150 with the same number of channels c₁. The expanded training layer 140A may receive, as an input, the set of the resulting c₁ channels in the 1×1 convolution. In a sense, each filter in the 1×1 convolution of the expanded training layer 140A thus provides for a weighted combination of the respective K×K convolutions of the expanded training layer 140B.

In one embodiment, the number of filters c₁ for the expanded training layer 140A is the same as the number of filters for convolutional filters 120 and expanded training layer 140B (e.g., c₁=c₂). In other embodiments, the number of filters c₁ for the expanded training layer 140A may be significantly higher, such as two or three times the number of filters (c₁>c₂). As such, when the number of filters c₁ increases, many additional filters may be learned that may then be combined by c₂ with the learned convolutional weighing to generate the layer output data 130. When the parameters are combined after training to the trained inference model 104, the resulting parameters for convolutional filters 120 may thus benefit from the additional filters in the expanded training layer 140A. In this example, the expanded training layer 140A may thus have the same dimensionality (K×K) as the convolutional filters 120 while allowing the number of such filters to change and be consolidated by the expanded training layer 140B.

In addition, while the expansion of the convolutional filters 120 are shown in FIG. 1 with respect to one convolutional layer, any number (or all) of the convolutional layers in the target model architecture 100 may be similarly expanded for training in the training model architecture 102 and converted to parameters for the trained inference model 104.

After generating the training model architecture 102 with the expanded training layers 140, the training model architecture 102 may be trained with the relevant training data and the expanded layers may be included as an in-line replacement in the training model architecture 102 for the convolutional filters 120. As such, while the expanded training layers 140 may add additional layers to the trained inference model 104, it does not otherwise affect training processes for the trained inference model 104, and normal model training approaches may be applied. The training model architecture 102 may be trained as discussed with respect to FIGS. 4-5.

After training, the parameters learned for the expanded training layers 140A-B are combined such that the respective parameters are “absorbed” to form parameters for the convolutional filters 120. That is, because the 1×1 convolutions of the expanded training layer 140B combined the K×K convolutions of the expanded training layer 140A, the mathematically equivalent result may be generated by combining the weights for inputs and c₀ channels of the filters in expanded training layer 140A according to the c₁ weight channels in the expanded training layer 140B. The filters of the expanded training layer 140A are designated matrix A and the filters of the expanded training layer 140B as matrix B in the following example equation for determining weights for a channel of matrix D of the convolutional filters 120:

$$\begin{matrix}{F}_{B : , : , 1} = {\sum }_{k = 1}^{{c}_{1}} {B}_{: , : , k}^{1} \times {F}_{A : , : , k} \\ = {\sum }_{k = 1}^{{c}_{1}} {B}_{: , : , k}^{1} \times ( {\sum }_{l = 1}^{{c}_{0}} {A}_{: , : , l}^{k} \times {F}_{: , : , l} ) \\ = {\sum }_{k = 1}^{{c}_{1}} {\sum }_{l = 1}^{{c}_{0}} {B}_{: , : , k}^{1} \times {A}_{: , : , l}^{k} * {F}_{: , : , l} \\ = {\sum }_{k = 1}^{{c}_{1}} {\sum }_{l = 1}^{{c}_{0}} ( {B}_{: , : , k}^{1} \times {A}_{: , : , l}^{k} ) * {F}_{: , : , l} \\ = {\sum }_{l = 1}^{{c}_{0}} {\sum }_{k = 1}^{{c}_{1}} ( {B}_{: , : , k}^{1} \times {A}_{: , : , l}^{k} ) * {F}_{: , : , l} \\ = {\sum }_{l = 1}^{{c}_{0}} {D}_{: , : , l}^{1} * {F}_{: , : , l}\end{matrix} \\ \text{Where:} \\ {D}_{: , : , l}^{1} = {\sum }_{k = 1}^{{c}_{1}} {\sum }_{k = 1}^{{c}_{1}} {B}_{: , : , k}^{1} \times {A}_{: , : , l}^{k} \qquad Equation 2$$

The corresponding versions of Eq. 2 may be applied to determine the weights for additional channels of the convolutional filters 120 for the trained inference model 104. As such, the convolutional layer may be expanded for training, trained with the expanded training layers 140, and transformed back to the original model architecture for inference without loss of information between the expanded training model architecture and the trained inference model 104.

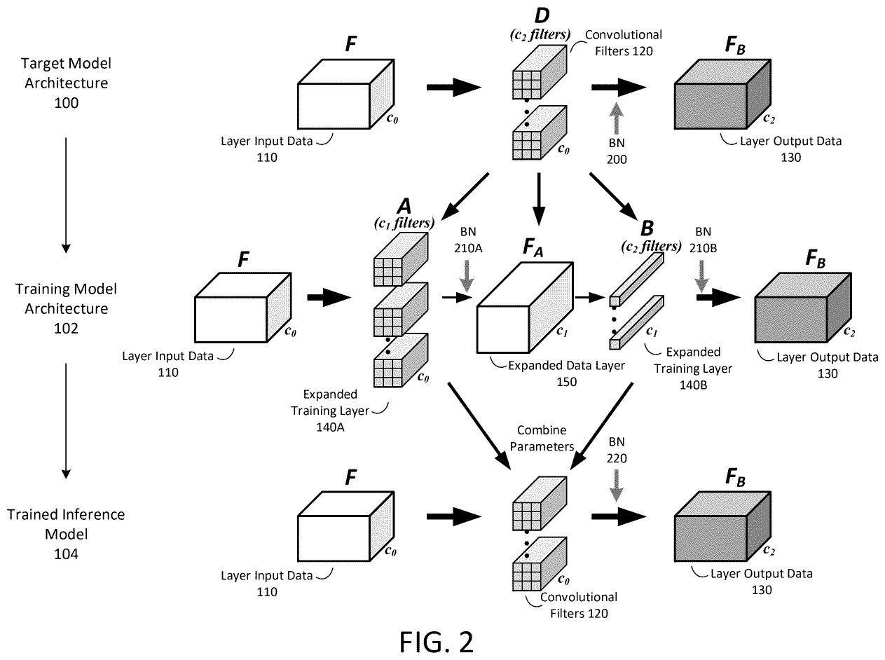

FIG. 2 shows another example of expanded training layers, according to one embodiment. Like the example of FIG. 1, the convolutional filters 120 may be expanded to expanded training layers 140 for training and the resulting parameters may be combined for inference. In this example, the inference model architecture includes a normalization layer, such as batch normalization (BN) 200 in the inference model architecture. To include this layer in the training model architecture, multiple batch normalization layers may be included, a batch normalization 210A after expanded training layer 140A, and batch normalization 210B after expanded training layer 140B. As with FIG. 1, the training model architecture is trained, and the parameters of the batch normalization 210A-B are combined to generate the parameters for batch normalization 220 used for inference. In addition to batch normalization, additional types of normalization may similarly be used, such as instance normalization (IN), group normalization (GN), and so forth. These different types of normalization may modify the dimension along which normalization is performed.

As a further illustration of batch normalization, Equation 3 shows a formal representation of BN 200 applied in the target model architecture 100:

$${F}_{B} = BN ( D * F ) \qquad Equation 3$$

As such, the batch normalization may apply to the result of the convolutional operation between the layer input data 110 and the convolutional filters 120 (D*F) and thus generate the layer output data 130 (F_{B}).

Equation 4 illustrates the operation of the Batch Normalization as applied to one channel in the target model architecture 100:

$${F}_{B : , : , 1} = BN ( {\sum }_{l = 1}^{{c}_{0}} {D}_{: , : , l}^{1} * {F}_{: , : , l} ) \qquad Equation 4$$

After training the training model architecture with BN layers 210A, 210B, the combination of the BN layers with the expanded training layers may be formally given by Equation 5, which is similar to Equation 2, modified to include the batch normalization layers:

$$\begin{matrix}{F}_{B : , : , 1} = {\sum }_{k = 1}^{{c}_{1}} {B}_{: , : , k}^{1} \times BN ( {\sum }_{l = 1} {A}_{: , : , l}^{k} * {F}_{: , : , l} ) \\ = {\sum }_{k = 1}^{{c}_{1}} {B}_{: , : , k}^{1} \times ( {\sum }_{l = 1}^{{c}_{0}} {A}_{: , : , l}^{k} * {F}_{: , : , l} \times {v}_{l} + {b}_{l} \times O ) \\ = {\sum }_{k = 1}^{{c}_{1}} {\sum }_{l = 1}^{{c}_{0}} ( {B}_{: , : , k}^{1} \times {A}_{: , : , l}^{k} * {F}_{: , : , l} \times {v}_{l} + {B}_{: , : , k}^{1} \times {b}_{l} \times O ) \\ = {\sum }_{l = 1}^{{c}_{0}} ( {\sum }_{k = 1}^{{c}_{1}} ( {B}_{: , : , l}^{1} \times {A}_{: , : , l}^{k} * {F}_{: , : , l} \times {v}_{l} ) + ( {B}_{: , : , k}^{1} \times {b}_{l} \times O ) ) \\ = {\sum }_{l = 1}^{{c}_{0}} {D}_{: , : , l}^{1} \times {F}_{: , : , l} + {d}_{l}^{1}\end{matrix} Where \\ {D}_{: , : , l}^{1} = {\sum }_{k = 1}^{{c}_{1}} {B}_{: , : , k}^{1} \times {A}_{: , : , l}^{k} \times {v}_{l} , {d}_{l}^{1} = {\sum }_{k = 1}^{{c}_{1}} {B}_{: , : , k}^{1} \times {b}_{l} ; \\ and \\ O is a matrix with all ones . \qquad Equation 5$$

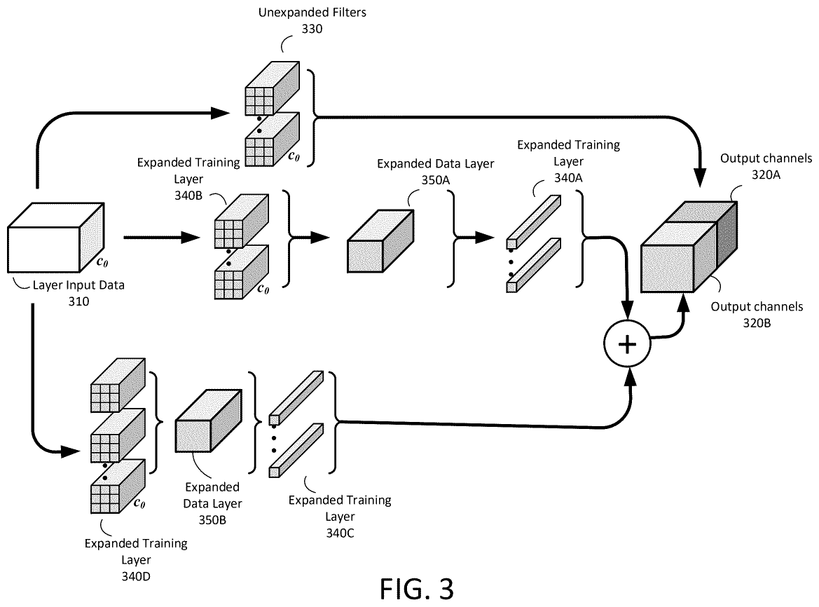

FIG. 3 shows an example training model architecture for a convolutional layer, according to one embodiment. While the example of FIG. 1 showed all filters of the convolutional layer expanded in the training model architecture 102, in the example of FIG. 3, some convolutional filters are not expanded in the training model architecture. In this example, a first portion of the filters of the convolutional layer are unexpanded filters 330 and may output a first set of output channels 320A. The filters for generating additional output channels 320B may be expanded to yield expanded training layers 340A-B.

The expansion of convolutional filters may be performed more than once—In this example, the output channels 320B may be generated in the training model architecture by summing results from expanded training layers across different “branches.” In this example, a first expanded training branch includes an expanded training layer 340A-B and expanded data layer 350A that is summed with a second expanded training branch that includes an expanded training layer 340C-D and expanded data layer 350B. The corresponding values for the model when the training layers are “absorbed” may be determined for each output channel in the set of output channels 320B by tracing the respective contribution of the layer input data 310 through the expanded training layers 340A-D and forming the equivalent values for the filter for that output channel in the inference model.

### Experimental Results

The expanded training process was applied to various data sets for comparison. In particular, the ImageNet-1k classification data set was evaluated with ResNet and EfficientNet backbones. In these experiments, all regular 3×3 convolutions were expanded during training with c₁=2c₂ and the trained parameters combined for the 3×3 parameters during inference.

TABLE 1

| Model | Top-1 accuracy (%) |
|---|---|
| ResNet18 w/regular convolution | 70.25 |
| ResNet18 w/absorbable convolution | 73.91(3.66↑) |
| ResNet50 w/regular convolution | 76.23 |
| ResNet50 w/absorbable convolution | 78.52(2.29↑) |
| ResNet101 w/regular convolution | 77.41 |
| ResNet101 w/absorbable convolution | 79.45(2.01↑) |
| ResNet152 w/regular convolution | 78.57 |
| ResNet152 w/absorbable convolution | 80.09(1.52↑) |

As shown by Table 1, the addition of the expanded layers and following combination of trained parameters (“absorbable convolution”) yielded significant improvements, particularly for shallower models with fewer layers (e.g., ResNet18).

A similar experiment was performed with the EfficientNet backbone:

TABLE 2

| Model | Top-1 accuracy (%) |
|---|---|
| EfficientNet-B0 w/regular convolution | 76.30 |
| EfficientNet-B0 w/absorbable convolution | 79.31(3.01↑) |
| EfficientNet-B1 w/regular convolution | 78.82 |
| EfficientNet-B1 w/absorbable convolution | 80.81(1.99↑) |
| EfficientNet-B7 w/regular convolution | 84.43 |
| EfficientNet-B7 w/absorbable convolution | 85.82(1.39↑) |

Table 2 confirms that the expanded training layers provide similar benefits to EfficientNet, and as with ResNet provide the most significant benefit for smaller model architectures.

### Example Computer Modeling

FIG. 4 shows example computer model inference and computer model training. Computer model inference refers to the application of a computer model 410 to a set of input data 400 to generate an output or model output 420. The computer model 410 determines the model output 420 based on parameters of the model, also referred to as model parameters. The parameters of the model may be determined based on a training process that finds an optimization of the model parameters, typically using training data and desired outputs of the model for the respective training data as discussed below. The output of the computer model may be referred to as an “inference” because it is a predictive value based on the input data 400 and based on previous example data used in the model training.

The input data 400 and the model output 420 vary according to the particular use case. For example, for computer vision and image analysis, the input data 400 may be an image having a particular resolution, such as 75×75 pixels, or a point cloud describing a volume. In other applications, the input data 400 may include a vector, such as a sparse vector, representing information about an object. For example, in recommendation systems, such a vector may represent user-object interactions, such that the sparse vector indicates individual items positively rated by a user. In addition, the input data 400 may be a processed version of another type of input object, for example representing various features of the input object or representing preprocessing of the input object before input of the object to the computer model 410. As one example, a 1024×1024 resolution image may be processed and subdivided into individual image portions of 64×64, which are the input data 400 processed by the computer model 410. As another example, the input object, such as a sparse vector discussed above, may be processed to determine an embedding or another compact representation of the input object that may be used to represent the object as the input data 400 in the computer model 410. Such additional processing for input objects may themselves be learned representations of data, such that another computer model processes the input objects to generate an output that is used as the input data 400 for the computer model 410. Although not further discussed here, such further computer models may be independently or jointly trained with the computer model 410.

As noted above, the model output 420 may depend on the particular application of the computer model 410, and represent recommendation systems, computer vision systems, classification systems, labeling systems, weather prediction, autonomous control, and any other type of modeling output/prediction.

The computer model 410 includes various model parameters, as noted above, that describe the characteristics and functions that generate the model output 420 from the input data 400. In particular, the model parameters may include a model structure, model weights, and a model execution environment. The model structure may include, for example, the particular type of computer model 410 and its structure and organization. For example, the model structure may designate a neural network, which may be comprised of multiple layers, and the model parameters may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 410 processes the input data 400 to the model output 420. Each portion or layer of the computer model 410 may have such weights. For example, weights may be used to determine values for processing inputs to determine outputs at a particular portion of a model. Stated another way, for example, model weights may describe how to combine or manipulate values of the input data 400 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model. For example, portions of the model may be implemented in various types of circuitry, such as general-purpose circuitry (e.g., a general CPU), circuitry specialized for certain computer model functions (e.g., a GPU or programmable Multiply-and-Accumulate circuit) or circuitry specially designed for the particular computer model application. In some configurations, different portions of the computer model 410 may be implemented on different types of circuitry. As discussed below, training of the model may include optimizing the types of hardware used for certain aspects of the computer model (e.g., co-trained), or may be determined after other parameters for the computer model are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters for the computer model 440. During training, the model parameters are optimized to “learn” values of the model parameters (such as individual weights, activation values, model execution environment, etc.), that improve the model parameters based on an optimization function that seeks to improve a cost function (also sometimes termed a loss function). Before training, the computer model 440 has model parameters that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 430 includes a data set to be used for training the computer model 440. The data set varies according to the particular application and purpose of the computer model 440. In supervised learning tasks, the training data typically includes a set of training data labels that describe the training data and the desired output of the model relative to the training data. For example, for an object classification task, the training data may include individual images in which individual portions, regions or pixels in the image are labeled with the classification of the object. For this task, the training data may include a training data image depicting a dog and a person and a training data labels that label the regions of the image that include the dog and the person, such that the computer model is intended to learn to also label the same portions of that image as a dog and a person, respectively.

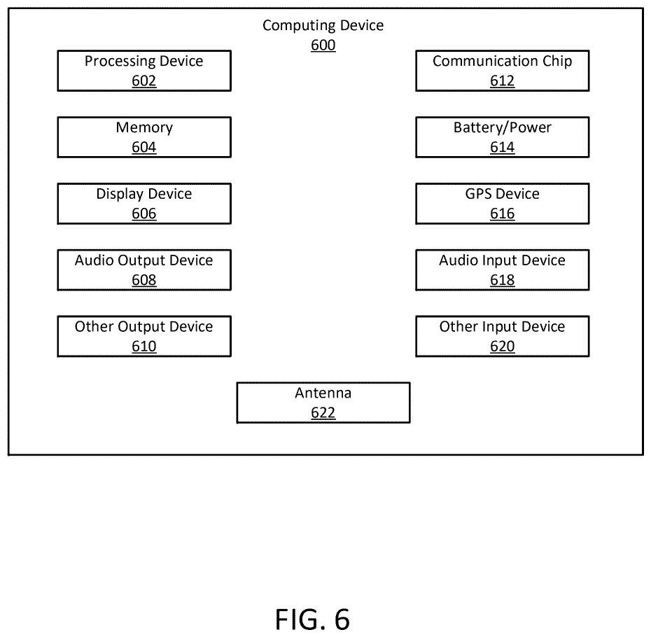

To train the computer model, a training module (not shown) applies the training data 430 to the computer model 440 to determine the outputs predicted by the model for given inputs for training data 430. The training module, though not shown, is a computing module used for performing the training of the computer model by executing the computer model according to its inputs and outputs given the model's parameters and modifying the model parameters based on the results. The training module may apply the actual execution environment of the computer model 440, or may simulate the results of the execution environment, for example to estimate the performance, runtime, memory, or circuit area (e.g., if specialized hardware is used) of the computer model. The training module, along with the training data and model evaluation, may be instantiated in software and/or hardware by one or more processing devices such as the example computing device 600 shown in FIG. 6. In various examples, the training process may also be performed by multiple computing systems in conjunction with one another, such as distributed/cloud computing systems.

After processing the training inputs according to the current model parameters for the computer model 440, the model's predicted outputs are evaluated 450 and the computer model is evaluated with respect to the cost function and optimized using an optimization function of the training model. Depending on the optimization function, particular training process and training parameters after the model evaluation are updated to improve the optimization function of the computer model. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model and may be measured in various ways, such as the precision (frequency of false positives) and recall (frequency of false negatives). The cost function in some circumstances may evaluate may also evaluate other characteristics of the model, for example the model complexity, processing speed, memory requirements, physical circuit characteristics (e.g., power requirements, circuit throughput) and other characteristics of the computer model structure and execution environment (e.g., to evaluate or modify these model parameters).

After determining results of the cost function, the optimization function determines a modification of the model parameters to improve the cost function for the training data. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data is batched and the parameter updates are iteratively applied to batches of the training data. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data available or the incremental improvements in the model parameters are below a threshold (e.g., additional training data no longer continues to improve the model parameters). Additional training parameters may describe the batch size for the training data, a portion of training data to use as validation data, the step size of parameter updates, a learning rate of the model, and so forth. Additional techniques may also be used to determine global optimums or address nondifferentiable model parameter spaces.

FIG. 5 illustrates an example neural network architecture. In general, a neural network includes an input layer 510, one or more hidden layers 520, and an output layer 530. The values for data in each layer of the network is generally determined based on one or more prior layers of the network. Each layer of a network generates a set of values, termed “activations” that represent the output values of that layer of a network and may be the input to the next layer of the network. For the input layer 510, the activations are typically the values of the input data, although the input layer 510 may represent input data as modified through one or more transformations to generate representations of the input data. For example, in recommendation systems, interactions between users and objects may be represented as a sparse matrix. Individual users or objects may then be represented as an input layer 510 as a transformation of the data in the sparse matrix relevant to that user or object. The neural network may also receive the output of another computer model (or several), as its input layer 510, such that the input layer 510 of the neural network shown in FIG. 5 is the output of another computer model.

Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network (except for the final output layer of 530 of the network.

Each layer of the neural network typically represents its output activations (i.e., also termed its outputs) in a matrix, which may be 1, 2, 3, or n-dimensional according to the particular structure of the network. As shown in FIG. 5, the dimensionality of each layer may differ according to the design of each layer. The dimensionality of the output layer 530 depend on the characteristics of the prediction made by the model. For example, a computer model for multi-object classification may generate an output layer 530 having a one-dimensional array in which each position in the array represents the likelihood of a different classification for the input layer 510. In another example for classification of portions of an image, the input layer 510 may be an image having a resolution, such as 512×512, and the output layer may be a 512×512×n matrix in which the output layer 530 provides n classification predictions for each of the input pixels, such that the corresponding position of each pixel in the input layer 510 in the output layer 530 is an n-dimensional array corresponding to the classification predictions for that pixel.

The hidden layers 520 provide output activations that variously characterize the input layer 510 in various ways that assist in effectively generating the output layer 530. The hidden layers thus may be considered to provide additional features or characteristics of the input layer 510. Though two hidden layers are shown in FIG. 5, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 530. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 510 is reached.

### Example Devices

FIG. 6 is a block diagram of an example computing device 600 that may include one or more components used for computer model training and inference in accordance with any of the embodiments disclosed herein. For example, the computing device 600 may include a training module for training models and executing functions of the computing device 600, and in some circumstances may include specialized hardware and/or software for computer model computation.

A number of components are illustrated in FIG. 6 as included in the computing device 600, but any one or more of these components may be omitted or duplicated, as suitable for the application. In some embodiments, some or all of the components included in the computing device 600 may be attached to one or more motherboards. In some embodiments, some or all of these components are fabricated onto a single system-on-a-chip (SoC) die.

Additionally, in various embodiments, the computing device 600 may not include one or more of the components illustrated in FIG. 6, but the computing device 600 may include interface circuitry for coupling to the one or more components. For example, the computing device 600 may not include a display device 606, but may include display device interface circuitry (e.g., a connector and driver circuitry) to which a display device 606 may be coupled. In another set of examples, the computing device 600 may not include an audio input device 618 or an audio output device 608 but may include audio input or output device interface circuitry (e.g., connectors and supporting circuitry) to which an audio input device 618 or audio output device 608 may be coupled.

The computing device 600 may include a processing device 602 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 602 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing device 600 may include a memory 604, which may itself include one or more memory devices such as volatile memory (e.g., dynamic random-access memory (DRAM)), nonvolatile memory (e.g., read-only memory (ROM)), flash memory, solid state memory, and/or a hard drive. The memory 604 may include instructions executable by the processing device for performing methods and functions as discussed herein. Such instructions may be instantiated in various types of memory, which may include non-volatile memory and as stored on one or more non-transitory mediums. In some embodiments, the memory 604 may include memory that shares a die with the processing device 602. This memory may be used as cache memory and may include embedded dynamic random-access memory (eDRAM) or spin transfer torque magnetic random-access memory (STT-MRAM).

In some embodiments, the computing device 600 may include a communication chip 612 (e.g., one or more communication chips). For example, the communication chip 612 may be configured for managing wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 612 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 612 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication chip 612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 612 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 612 may operate in accordance with other wireless protocols in other embodiments. The computing device 600 may include an antenna 622 to facilitate wireless communications and/or to receive other wireless communications (such as AM or FM radio transmissions).

In some embodiments, the communication chip 612 may manage wired communications, such as electrical, optical, or any other suitable communication protocols (e.g., the Ethernet). As noted above, the communication chip 612 may include multiple communication chips. For instance, a first communication chip 612 may be dedicated to shorter-range wireless communications such as Wi-Fi or Bluetooth, and a second communication chip 612 may be dedicated to longer-range wireless communications such as global positioning system (GPS), EDGE, GPRS, CDMA, WiMAX, LTE, EV-DO, or others. In some embodiments, a first communication chip 612 may be dedicated to wireless communications, and a second communication chip 612 may be dedicated to wired communications.

The computing device 600 may include battery/power circuitry 614. The battery/power circuitry 614 may include one or more energy storage devices (e.g., batteries or capacitors) and/or circuitry for coupling components of the computing device 600 to an energy source separate from the computing device 600 (e.g., AC line power).

The computing device 600 may include a display device 606 (or corresponding interface circuitry, as discussed above). The display device 606 may include any visual indicators, such as a heads-up display, a computer monitor, a projector, a touchscreen display, a liquid crystal display (LCD), a light-emitting diode display, or a flat panel display, for example.

The computing device 600 may include an audio output device 608 (or corresponding interface circuitry, as discussed above). The audio output device 608 may include any device that generates an audible indicator, such as speakers, headsets, or earbuds, for example.

The computing device 600 may include an audio input device 618 (or corresponding interface circuitry, as discussed above). The audio input device 618 may include any device that generates a signal representative of a sound, such as microphones, microphone arrays, or digital instruments (e.g., instruments having a musical instrument digital interface (MIDI) output).

The computing device 600 may include a GPS Device 616 (or corresponding interface circuitry, as discussed above). The GPS Device 616 may be in communication with a satellite-based system and may receive a location of the computing device 600, as known in the art.

The computing device 600 may include an other output device 610 (or corresponding interface circuitry, as discussed above). Examples of the other output device 610 may include an audio codec, a video codec, a printer, a wired or wireless transmitter for providing information to other devices, or an additional storage device.

The computing device 600 may include an other input device 620 (or corresponding interface circuitry, as discussed above). Examples of the other input device 620 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 600 may have any desired form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device. In some embodiments, the computing device 600 may be any other electronic device that processes data.

### Select Examples

The following paragraphs provide various examples of the embodiments disclosed herein.

Example 1 provides a method including: identifying a convolutional layer having a plurality of convolutional filters of a target model architecture; generating a training model architecture by replacing a first number of the plurality of convolutional filters in the target model architecture with a plurality of expanded training layers; training parameters of the training model architecture; and determining parameters for a trained inference model having the target model architecture based on the parameters of the training model architecture, wherein parameters of the first number of the plurality of convolutional filters are determined by combining parameters of the plurality of expanded training layers.

Example 2 provides for the method of example 1, wherein the plurality of expanded layers includes an output expanded layer that outputs a result of the expanded training layers and has a different dimensionality than a dimensionality of the plurality of convolutional filters in the target model architecture.

Example 3 provides for the method of example 2, wherein the output expanded layer has a dimensionality of 1×1.

Example 4 provides for the method of example 2, wherein the plurality of expanded training layers includes a training layer having a dimensionality matching the dimensionality of the plurality of the convolutional filters in the target model architecture.

Example 5 provides for the method of any of examples 1-4, wherein at least one of the expanded training layers has a second number of convolutional filters larger than the first number.

Example 6 provides for the method of any of examples 1-5, wherein the first number of the plurality of convolutional filters is a portion of the plurality of convolutional filters.

Example 7 provides for the method of any of examples 1-6, wherein the plurality of expanded training layers includes normalization layers.

Example 8 provides a for a system including a processor; and a non-transitory computer-readable storage medium containing computer program code for execution by the processor for: identifying a convolutional layer having a plurality of convolutional filters of a target model architecture; generating a training model architecture by replacing a first number of the plurality of convolutional filters in the target model architecture with a plurality of expanded training layers; training parameters of the training model architecture; and determining parameters for a trained inference model having the target model architecture based on the parameters of the training model architecture, wherein parameters of the first number of the plurality of convolutional filters are determined by combining parameters of the plurality of expanded training layers.

Example 9 provides for the system of example 8, wherein the plurality of expanded layers includes an output expanded layer that outputs a result of the expanded training layers and has a different dimensionality than a dimensionality of the plurality of convolutional filters in the target model architecture.

Example 10 provides for the system of example 9, wherein the output expanded layer has a dimensionality of 1×1.

Example 11 provides for the system of example 9, wherein the plurality of expanded training layers includes a training layer having a dimensionality matching the dimensionality of the plurality of the convolutional filters in the target model architecture.

Example 12 provides for the system of any of examples 8-11, wherein at least one of the expanded training layers has a second number of convolutional filters larger than the first number.

Example 13 provides for the system of any of examples 8-12, wherein the first number of the plurality of convolutional filters is a portion of the plurality of convolutional filters.

Example 14 provides for the system of any of examples 8-13, wherein the plurality of expanded training layers includes normalization layers.

Example 15 provides for a non-transitory computer-readable storage medium containing instructions executable by a processor for: identifying a convolutional layer having a plurality of convolutional filters of a target model architecture; generating a training model architecture by replacing a first number of the plurality of convolutional filters in the target model architecture with a plurality of expanded training layers; training parameters of the training model architecture; and determining parameters for a trained inference model having the target model architecture based on the parameters of the training model architecture, wherein parameters of the first number of the plurality of convolutional filters are determined by combining parameters of the plurality of expanded training layers

Example 16 provides for the non-transitory computer-readable storage medium of example 15, wherein the plurality of expanded layers includes an output expanded layer that outputs a result of the expanded training layers and has a different dimensionality than a dimensionality of the plurality of convolutional filters in the target model architecture.

Example 17 provides for the non-transitory computer-readable storage medium of example 16, wherein the output expanded layer has a dimensionality of 1×1.

Example 18 provides for the non-transitory computer-readable medium of example 16, wherein the plurality of expanded training layers includes a training layer having a dimensionality matching the dimensionality of the plurality of the convolutional filters in the target model architecture.

Example 19 provides for the non-transitory computer-readable medium of any of examples 15-18, wherein at least one of the expanded training layers has a second number of convolutional filters larger than the first number.

Example 20 provides for the non-transitory computer-readable medium of any of examples 15-19, wherein the first number of the plurality of convolutional filters is a portion of the plurality of convolutional filters.

Example 21 provides for the non-transitory computer-readable medium of any of examples 15-20, wherein the plurality of expanded training layers includes normalization layers.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. A method comprising:
identifying a convolutional layer having a plurality of convolutional filters of a target model architecture;
generating a training model architecture by replacing a first number of the plurality of convolutional filters in the target model architecture with a plurality of expanded training layers;
training parameters of the training model architecture; and
determining parameters for a trained inference model having the target model architecture based on the parameters of the training model architecture, wherein parameters of the first number of the plurality of convolutional filters are determined by combining parameters of the plurality of expanded training layers.

2. The method of claim 1, wherein the plurality of expanded layers includes an output expanded layer that outputs a result of the expanded training layers and has a different dimensionality than a dimensionality of the plurality of convolutional filters in the target model architecture.

3. The method of claim 2, wherein the output expanded layer has a dimensionality of 1×1.

4. The method of claim 2, wherein the plurality of expanded training layers includes a training layer having a dimensionality matching the dimensionality of the plurality of the convolutional filters in the target model architecture.

5. The method of claim 1, wherein at least one of the expanded training layers has a second number of convolutional filters larger than the first number.

6. The method of claim 1, wherein the first number of the plurality of convolutional filters is a portion of the plurality of convolutional filters.

7. The method of claim 1, wherein the plurality of expanded training layers includes normalization layers.

8. A system comprising:
a processor; and
a non-transitory computer-readable storage medium containing computer program code for execution by the processor for:
identifying a convolutional layer having a plurality of convolutional filters of a target model architecture,
generating a training model architecture by replacing a first number of the plurality of convolutional filters in the target model architecture with a plurality of expanded training layers,
training parameters of the training model architecture, and
determining parameters for a trained inference model having the target model architecture based on the parameters of the training model architecture, wherein parameters of the first number of the plurality of convolutional filters are determined by combining parameters of the plurality of expanded training layers.

9. The system of claim 8, wherein the plurality of expanded layers includes an output expanded layer that outputs a result of the expanded training layers and has a different dimensionality than a dimensionality of the plurality of convolutional filters in the target model architecture.

10. The system of claim 9, wherein the output expanded layer has a dimensionality of 1×1.

11. The system of claim 9, wherein the plurality of expanded training layers includes a training layer having a dimensionality matching the dimensionality of the plurality of the convolutional filters in the target model architecture.

12. The system of claim 8, wherein at least one of the expanded training layers has a second number of convolutional filters larger than the first number.

13. The system of claim 8, wherein the first number of the plurality of convolutional filters is a portion of the plurality of convolutional filters.

14. The system of claim 8, wherein the plurality of expanded training layers includes normalization layers.

15. A non-transitory computer-readable storage medium containing instructions executable by a processor for:
identifying a convolutional layer having a plurality of convolutional filters of a target model architecture;
generating a training model architecture by replacing a first number of the plurality of convolutional filters in the target model architecture with a plurality of expanded training layers;
training parameters of the training model architecture; and
determining parameters for a trained inference model having the target model architecture based on the parameters of the training model architecture, wherein parameters of the first number of the plurality of convolutional filters are determined by combining parameters of the plurality of expanded training layers.

16. The non-transitory computer-readable medium of claim 15, wherein the plurality of expanded layers includes an output expanded layer that outputs a result of the expanded training layers and has a different dimensionality than a dimensionality of the plurality of convolutional filters in the target model architecture.

17. The non-transitory computer-readable medium of claim 16, wherein the output expanded layer has a dimensionality of 1×1.

18. The non-transitory computer-readable medium of claim 16, wherein the plurality of expanded training layers includes a training layer having a dimensionality matching the dimensionality of the plurality of the convolutional filters in the target model architecture.

19. The non-transitory computer-readable medium of claim 15, wherein at least one of the expanded training layers has a second number of convolutional filters larger than the first number.

20. The non-transitory computer-readable medium of claim 15, wherein the first number of the plurality of convolutional filters is a portion of the plurality of convolutional filters.
